(19) United States
(12) Patent Application Publication
(10) Pub. No.: US 2024/0359761 A1
(43) Pub. Date: Oct. 31, 2024

(54) Bicycle Spinner Peg Device

(71) Applicants: Cesar Zamora, San Diego, CA (US); Tonja Zamora, San Diego, CA (US)

(72) Inventors: Cesar Zamora, San Diego, CA (US); Tonja Zamora, San Diego, CA (US)

(21) Appl. No.: 18/460,764

(22) Filed: Sep. 5, 2023

Related U.S. Application Data
(60) Provisional application No. 63/462,341, filed on Apr. 27, 2023.

(51) Int. Cl. B62J 25/06

(52) U.S. Cl. CPC B62J 25/06

(57) ABSTRACT

A bicycle spinner peg device is provided. The device is comprised of a shaft with at least one wheel which spins around the shaft. The shaft also receives a fender, which rests above the wheel, that attaches to the shaft in a non-rotational manner. The device is also comprised of a peg thread that allows the device to attach to the peg receiving area of a bicycle. As a result, a user can use the wheel of the peg to roll along a surface while performing a BMX trick. While doing so, the user can also stand on the fender, which does not rotate as the wheel rolls along the surface.

### CROSS-REFERENCE TO RELATED APPLICATION

The present application claims priority to, and the benefit of, U.S. Provisional Application No. 63/462,341, which was filed on Apr. 27, 2023, and is incorporated herein by reference in its entirety.

### FIELD OF THE INVENTION

The present invention relates generally to the field of bicycles. More specifically, the present invention relates to a bicycle spinner peg device that provides a peg with a spinning wheel that can be used to roll along a surface, in addition to a fender above the wheel which functions as a non-rotational standing surface for a user's foot. Accordingly, the present disclosure makes specific reference thereto. Nonetheless, it is to be appreciated that aspects of the present invention are also equally applicable to other like applications, devices, and methods of manufacture.

### BACKGROUND

Sliding or grinding on a BMX bike is a dynamic maneuver that involves sliding along the surface of an obstacle, typically a rail, wall, ledge, or edge, while maintaining balance and control. This skill is a fundamental aspect of BMX freestyle riding and requires a combination of technique, coordination, and confidence. However, BMX riders often seek to elevate their riding experience by pushing the boundaries of creativity and skill through an array of daring tricks and gravity-defying stunts. As a result, BMX riders are always exploring new ways to express their creativity and challenge themselves. Therefore, conventional pedals and pegs traditionally utilized for grinding along rails and walls, while functional, can sometimes present a formidable challenge, leading to moments of frustration and limitations in executing the full spectrum of tricks.

Therefore, there exists a long-felt need in the art for an improved BMX peg. There also exists a long-felt need in the art for a bicycle spinner peg device that keeps the BMX sport fresh and exciting for both riders and spectators. More specifically, there exists a long-felt need in the art for a bicycle spinner peg device that allows a BMX rider to attempt novel tricks and combinations that were previously difficult or impossible with existing standard-type pegs known in the art. In addition, there exists a long-felt need in the art for a bicycle spinner peg device that provides a spinning peg that can simultaneously be used as a stationary standing structure while performing BMX tricks.

The subject matter disclosed and claimed herein, in one embodiment thereof, comprises a bicycle spinner peg device. The device is comprised of a shaft with at least one wheel which spins around the shaft. The shaft also receives a fender, which rests above the wheel, that attaches to the shaft in a non-rotational manner. The device is also comprised of a peg thread that allows the device to attach to the peg receiving area of a bicycle. As a result, a user can use the wheel of the peg to roll along a surface while performing a BMX trick. While doing so, the user can also stand on the fender, which does not rotate as the wheel rolls along the surface.

In this manner, the bicycle spinner peg device of the present invention accomplishes all the foregoing objectives and provides an improved BMX peg. More specifically, the device keeps the BMX sport fresh and exciting for both riders and spectators by allowing a BMX rider to attempt novel tricks and combinations that were previously difficult or impossible with existing standard-type pegs known in the art. To do so, the device provides a spinning peg that can simultaneously be used as a stationary standing structure while performing BMX tricks.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a bicycle spinner peg device. The device is designed to attach to the bicycle peg receiving structure of a BMX bicycle (or other bicycle or vehicle/device of the like), wherein the device functions as a peg via at least one fender that a user can stand on. In addition, at least one wheel of the device can be used to allow a user to roll/grind on various surfaces, wherein the wheel rotates around a shaft.

The device is comprised of a shaft that is placed through at least one opening of at least one bearing of at least one wheel. The bearing spins 360 degrees around the shaft to allow the wheel to spin 360 degrees around the shaft. The first end may also receive at least one fastener, such as, but not limited to, a nut, which secures the wheels onto the shaft. The first end may also receive at least one peg thread. A threaded exterior surface of the peg allows the device to attach to a female peg receiving area of a BMX bicycle (or other bicycle or vehicle/device of the like).

During use, the wheel and/or bearing rotates around the shaft to allow the wheel to spin while rolling over a surface while grinding or otherwise performing a bicycle trick (when the device is attached to a bicycle in a peg location via the peg thread). To allow the device to still function as a traditional peg, a user can stand on the fender while performing a grind/trick. The fender preferably has a convex body. The body attaches to the shaft via at least one support post that is preferably perpendicular to the body. The post has at least one fastener which attaches to the shaft in a non-rotational manner. As a result, the body remains parallel to a grinding/ground surface during use, even when the wheel is in motion and is rolling/grinding off said surface.

The present invention is also comprised of a method of using the device. First, a device is provided comprised of at least one shaft, at least one wheel with at least one bearing wherein the shaft is positioned through an opening of the bearing, and at least one fender attached to the shaft in a non-rotational manner. Then, the shaft can be positioned through an opening of the bearing. Next, the wheel can be secured on the shaft by placing at least one fastener and/or at least one spacer on the shaft. Then, a user can attach at least one fender to the shaft via at least one fastener of the fender. Next, a user can place a peg threaded on the shaft and then attach the peg thread to the female peg receiving area of a bicycle. Finally, a user can ride the bicycle while standing on the fender and rolling the wheel over a surface such as, but not limited to, a wall, a ledge, a rail, etc., to perform a BMX trick.

Accordingly, the bicycle spinner peg device of the present invention is particularly advantageous as it provides an improved BMX peg. More specifically, the device keeps the BMX sport fresh and exciting for both riders and spectators by allowing a BMX rider to attempt novel tricks and combinations that were previously difficult or impossible with existing standard-type pegs known in the art. To do so, the device provides a spinning peg that can simultaneously be used as a stationary standing structure while performing BMX tricks. In this manner, the bicycle spinner peg device overcomes the limitations of existing bicycle pegs known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a bicycle spinner peg device of the present invention while unassembled and without a fender in accordance with the disclosed architecture;

FIG. 2 illustrates a perspective view of one potential embodiment of a bicycle spinner peg device of the present invention while assembled and without a fender in accordance with the disclosed architecture;

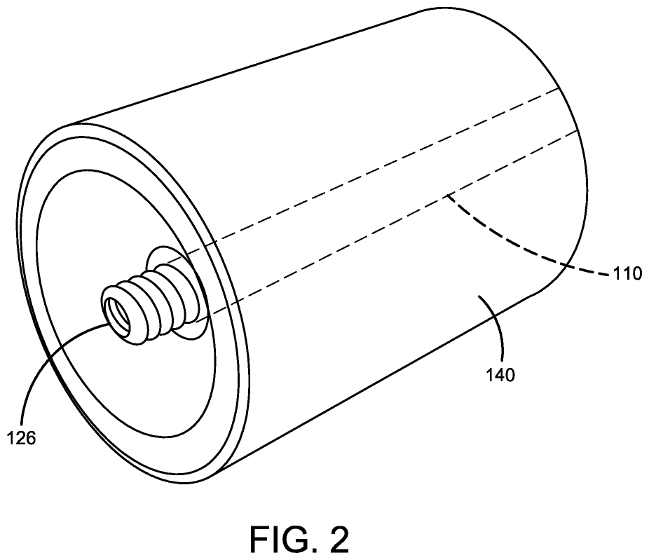

FIG. 3 illustrates a perspective view of one potential embodiment of a bicycle spinner peg device of the present invention while assembled and with a fender in accordance with the disclosed architecture; and

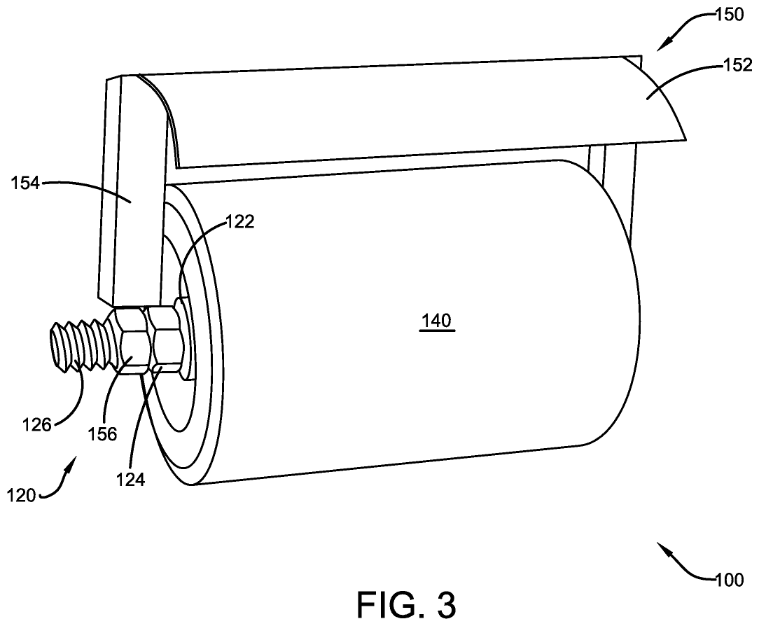

FIG. 4 illustrates a flowchart of a method of using one potential embodiment of a bicycle spinner peg device of the present invention in accordance with the disclosed architecture.

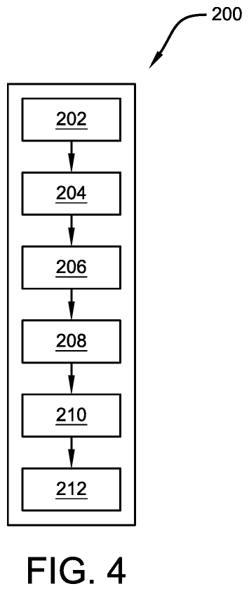

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved BMX peg. There also exists a long-felt need in the art for a bicycle spinner peg device that keeps the sport fresh and exciting for both riders and spectators. More specifically, there exists a long-felt need in the art for a bicycle spinner peg device that allows a BMX rider to attempt novel tricks and combinations that were previously difficult or impossible with existing standard-type pegs known in the art. In addition, there exists a long-felt need in the art for a bicycle spinner peg device that provides a spinning peg that can simultaneously be used as a stationary standing structure while performing BMX tricks.

The present invention, in one exemplary embodiment, is comprised of a bicycle spinner peg device designed to attach to the bicycle peg receiving structure of a BMX bicycle (or other bicycle or vehicle/device of the like). During use, the device functions as a peg via at least one fender that a user can stand on. In addition, at least one wheel of the device can be used to allow a user to roll/grind on various surfaces, wherein the wheel rotates around a shaft.

The device is comprised of a shaft that is placed through at least one opening of at least one bearing of at least one wheel. The bearing spins 360 degrees around the shaft to allow the wheel to spin 360 degrees around the shaft. The first end may also receive at least one fastener, such as, but not limited to, a nut, which secures the wheels onto the shaft. The first end may also receive at least one peg thread, wherein a threaded exterior surface of the peg allows the device to attach to a female peg receiving area of a BMX bicycle (or other bicycle or vehicle/device of the like).

During use, the wheel and/or bearing rotates around the shaft to allow the wheel to spin while rolling over a surface while grinding or otherwise performing a bicycle trick (when the device is attached to a bicycle in a peg location via the peg thread). To allow the device to still function as a traditional peg, a user can stand on the fender while performing a grind/trick. The fender preferably has a convex body that attaches to the shaft via at least one support post that is preferably perpendicular to the body. The post has at least one fastener which attaches to the shaft in a non-rotational manner. As a result, the body remains parallel to a grinding/ground surface during use, even when the wheel is in motion and is rolling/grinding off said surface.

The present invention is also comprised of a method of using the device. First, a device is provided comprised of at least one shaft, at least one wheel with at least one bearing wherein the shaft is positioned through an opening of the bearing, and at least one fender attached to the shaft in a non-rotational manner. Then, the shaft can be positioned through an opening of the bearing. Next, the wheel can be secured on the shaft by placing at least one fastener and/or at least one spacer on the shaft. Then, a user can attach at least one fender to the shaft via at least one fastener of the fender. Next, a user can place a peg threaded on the shaft and then attach the peg thread to the female peg receiving area of a bicycle. Finally, a user can ride the bicycle while standing on the fender and rolling the wheel over a surface such as, but not limited to, a wall, a ledge, a rail, etc., to perform a BMX trick.

Accordingly, the bicycle spinner peg device of the present invention is particularly advantageous as it provides an improved BMX peg. More specifically, the device keeps the BMX sport fresh and exciting for both riders and spectators by allowing a BMX rider to attempt novel tricks and combinations that were previously difficult or impossible with existing standard-type pegs known in the art. To do so, the device provides a spinning peg that can simultaneously be used as a stationary standing structure while performing BMX tricks. In this manner, the bicycle spinner peg device overcomes the limitations of existing bicycle pegs known in the art.

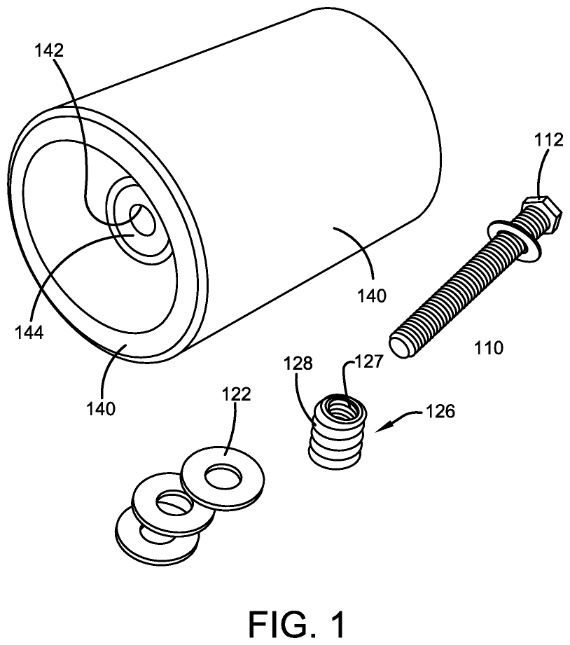

Referring initially to the drawings, FIG. 1 illustrates a perspective view of one potential embodiment of a bicycle spinner peg device 100 of the present invention while unassembled and without a fender 150 in accordance with the disclosed architecture. The device 100 is designed to attach to the bicycle peg receiving structure of a BMX bicycle (or other bicycle or vehicle/device of the like). During use, the device 100 functions as a peg via at least one fender 150 that a user can stand on. In addition, at least one wheel 140 of the device 100 can be used to allow a user to roll/grind on various surfaces, wherein the wheel 140 rotates around a shaft 110.

The device 100 is comprised of a shaft 110. The shaft 110 is preferably made from a metal material. The shaft 110 may be threaded or non-threaded in different embodiments. The shaft 110 is placed through at least one opening 142 of at least one bearing 144 of at least one wheel 140. The bearing 144 spins 360 degrees around the shaft 110 to allow the wheel 140 to spin 360 degrees around the shaft 110. The bearing 144 may be any roller-type bearing known in the art. The wheel 140 may be any type of wheel known in the art. The wheel 140 is preferably made from a plastic material such as, but not limited to, polyurethane.

The first end 120 of the shaft 110 may receive at least one spacer 122 of any type known in the art. The first end 120 may also receive at least one fastener 124, such as, but not limited to, a nut, which secures the wheels 140 onto the shaft 110. The first end 120 may also receive at least one peg thread 126. The thread 126 may have a threaded interior space 127 to allow the peg 126 to attach to the first end 120 of the shaft 110 (in an embodiment wherein the shaft 110 is threaded) and a threaded exterior surface 128 which allows the device 100 to attach to a female peg receiving area of a BMX bicycle (or other bicycle or vehicle/device of the like). In various embodiments, all components may be removably or fixedly attached to one another to form the device 100.

All of the said components 122, 124, 126 may also be present on the second end 130 of the shaft 110. In another embodiment, the second end 130 is comprised of a head 112 of the shaft 110. The head 112 prevents the wheel 140 from falling off the shaft 110 from the second end 130.

During use, the wheel 140 and/or bearing 144 rotates around the shaft 110 to allow the wheel 140 to spin while rolling over a surface while grinding or otherwise performing a bicycle trick (when the device 100 is attached to a bicycle in a peg location via the peg thread 126). To allow the device 100 to still function as a traditional peg, a user can stand on the fender 150 while performing a grind/trick.

The fender 150 preferably has a convex body and is made of a metal material. The body 152 may be a textured body with knurling (or other surface texture of the like) to promote grip between the fender 150 and a user's foot. The body 152 attaches to the shaft 110 via at least one support post 154 that is preferably perpendicular to the body 152. The post 154 has at least one fastener 156 which attaches to the shaft 110. The fastener 156 is preferably, but not limited to, a nut. In this manner, the fender 150 attaches to the shaft 110 in a non-rotational manner. As a result, the body 152 remains parallel to a grinding/ground surface during use, even when the wheels 140 are in motion and are rolling/grinding off said surface.

The present invention is also comprised of a method of using 200 the device 100. First, a device 100 is provided comprised of at least one shaft 110, at least one wheel 140 with at least one bearing 144 wherein the shaft 110 is positioned through an opening 142 of the bearing 144, and at least one fender 150 attached to the shaft 110 in a non-rotational manner [Step 202]. Then, the shaft 110 can be positioned through an opening 142 of the bearing 144 [Step 204]. Next, the wheel 140 can be secured on the shaft 110 via placing at least one fastener 124 and/or at least one spacer 122 on the shaft 110 [Step 206]. Then, a user can attach at least one fender 150 to the shaft 110 via at least one fastener 156 of the fender 150 [Step 208]. Next, a user can place a peg threaded 126 on the shaft 110 and then attach the peg thread 126 to the female peg receiving area of a bicycle [Step 210]. Finally, a user can ride the bicycle while standing on the fender 150 and rolling the wheel 140 over a surface such as, but not limited to, a wall, a ledge, a rail, etc. to perform a BMX trick [Step 212].

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “bicycle spinner peg device” and “device” are interchangeable and refer to the bicycle spinner peg device 100 of the present invention.

Notwithstanding the foregoing, the bicycle spinner peg device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the bicycle spinner peg device 100 as shown in the FIGS. are for illustrative purposes only, and that many other sizes and shapes of the bicycle spinner peg device 100 are well within the scope of the present disclosure. Although the dimensions of the bicycle spinner peg device 100 are important design parameters for user convenience, the bicycle spinner peg device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A bicycle spinner peg device comprising:
a shaft;
a wheel comprised of a bearing, the bearing comprised of an opening;
a fender comprised of a body and a support post; and
a peg thread.

2. The bicycle spinner peg device of claim 1, wherein the support post attaches to the shaft.

3. The bicycle spinner peg device of claim 2, wherein the support post attaches to the shaft in a non-rotational manner.

4. The bicycle spinner peg device of claim 1, wherein the wheel can rotate 360 degrees around the shaft.

5. The bicycle spinner peg device of claim 1, wherein the bearing can rotate 360 degrees around the shaft.

6. The bicycle spinner peg device of claim 1, wherein the wheel can rotate 360 degrees around the bearing.

7. The bicycle spinner peg device of claim 1, wherein the wheel is comprised of a polyurethane material.

8. A bicycle spinner peg device comprising:
a shaft;
a wheel comprised of a bearing, the bearing comprised of an opening;
a fender comprised of a body and a support post comprised of a first fastener;
a second fastener; and
a peg thread.

9. The bicycle spinner peg device of claim 8, wherein the second fastener is comprised of a nut.

10. The bicycle spinner peg device of claim 8, wherein the second fastener is comprised of a spacer.

11. The bicycle spinner peg device of claim 8, wherein the first fastener is comprised of a nut.

12. The bicycle spinner peg device of claim 8, wherein the shaft is comprised of a threaded shaft.

13. The bicycle spinner peg device of claim 8, wherein the shaft is comprised of a head.

14. The bicycle spinner peg device of claim 8, wherein the bearing is positioned around the shaft.

15. The bicycle spinner peg device of claim 8, wherein the body of the fender is comprised of a knurling.

16. The bicycle spinner peg device of claim 8, wherein the body of the fender is comprised of a convex body.

17. The bicycle spinner peg device of claim 8, wherein the peg thread is comprised of a threaded interior surface.

18. The bicycle spinner peg device of claim 8, wherein the peg thread is comprised of a threaded exterior surface.

19. A method of using a bicycle spinner peg device, the method comprising the following steps:
providing a bicycle spinner peg device comprised of a shaft, a wheel with a bearing, and a fender attached to the shaft in a non-rotational manner;
attaching a peg thread of the bicycle spinner peg device to a female peg receiving area of a bicycle;
riding a bicycle while standing on the fender and rolling the wheel over to perform a trick.

20. The method of using a bicycle spinner peg device of claim 19, wherein the surface is comprised of a wall, a ledge, or a rail.
